(19) United States
(12) Patent Application Publication
(10) Pub. No.: US 2006/0146059 A1
(43) Pub. Date: Jul. 6, 2006

(54) Apparatus, method and program product for rearraging frames

(75) Inventors: Motoharu Inoue, Yokohama (JP); Kohichi Nakamura, Tokyo-to (JP)

Correspondence Address: HOFFMAN, WARNICK & D'ALESSANDRO LLC, 75 STATE ST, 14TH, ALBANY, NY, 12207, US

(73) Assignee: International Business Machines Corporation, Armonk, NY (US)

(21) Appl. No.: 11/314,990

(22) Filed: Dec. 21, 2005

(30) Foreign Application Priority Data
Jan. 4, 2005 (JP) 2005-000110

(51) Int. Cl. G09G 5/397

(52) U.S. Cl. 345/546

(57) ABSTRACT

An apparatus including a display unit for rearranging frames in a window that includes an event handler module for processing position coordinate data on a window object displayed on the display unit; a frame boundary rotatable determination module that obtains position coordinate data of an end point of the frame boundary formed in the window object so as to determine that the end point is rotatable around a specific end point; and a layout manager for processing coordinate conversion of the specific end point to the end point determined as being rotatable, calculating position coordinate data for changing the frame boundary to generate a predicted window object to be displayed, and storing the predicted window object into a memory unit apart from the window object. A method of providing a graphical user interface and a program product for providing the graphical user interface comprising similar attributes is disclosed.

### CLAIM FOR PRIORITY

This application claims the benefit of Japanese Patent Application No. 2005-000110, filed Jan. 4, 2005, which is hereby incorporated herein.

### FIELD OF THE INVENTION

The present invention generally relates to a rearrangement technique of a frame displayed in a window, and more particularly relates to an information processing apparatus including a graphical user interface, which rearranges the frame without impairing visibility of a text displayed in a predetermined frame to a user, a frame rearrangement method, and a program thereof.

### BACKGROUND OF THE INVENTION

With an increase in speed and high-performance of a computer, a plurality of frames are formed in one window at present, and while displaying different data or documents in respective frames, operations are executed in many cases. A method of changing a frame arrangement in a window, which has conventionally been used, is shown in FIG. 10 (see also, e.g., www.eclipse.org). Conventionally, as shown in FIG. 10, a plurality of frames 102, 104, 106, and 108 are formed in one window 100, and different objects are allocated in respective frames. Also, different data or documents given by the objects are displayed. Conventionally, as shown in FIG. 10, when a user intends to change a size of a frame boundary, the user will position a pointer cursor 120 on a frame borderline through an input unit such as a mouse or a touchpad, and move the mouse in a direction where the user wants to move while clicking the mouse.

A conventional method in case of changing a frame allocation within the window 100 shown in FIG. 10 is shown in FIG. 11. When the pointer cursor is positioned to a frame boundary to which the user wants to move a frame 104 in response to an instruction from pointer means such as a mouse, the pointer icon will be changed into a shape of indicating to be movable. After recognizing the change of this icon, the user moves the frame in a predetermined direction on the window. In response to this user's operation, a window manager generates a corresponding frame boundary, moves the generated frame boundary in the same direction as the move of the pointer cursor, and displays data or a document given by the object therein. At this time, as shown in FIG. 11, the boundary of the adjacent frame 106 which shares the frame boundary with the frame 104 to be moved is moved in an inside direction of the frame. For this reason, as shown in FIG. 11, the frame 106 is decreased in the area with an expansion of the frame 104 and the frame 108, and as a result, visibility of the data or the document will almost be lost. Meanwhile, although the frame that the user wants to expand is only the frame 104 in original, it is shown that the frame 106 is also expanded.

In order to solve this problem, for example, it is also possible to set that respective frame boundaries to which the respective frames are adjacent may be moved. However, it is impossible for the user to know from which one to which one of the frame boundaries could independently be moved and/or could be jointly moved only by changing the shape of the pointer cursor, as also shown in FIG. 10 and FIG. 11. Furthermore, it is necessary to improve the usability.

Further, a technique for improving the visibility of the frame in a multi-window display, is disclosed in, for example, Japanese Published Patent Application No. H10-171624, but a high efficient rearrangement of the frames displayed within the window is not disclosed therein at all.

### SUMMARY OF THE INVENTION

That is to say, until now, it has been required to expand only a specific frame among a plurality of frames displayed in one window while suppressing the effect on other frames as little as possible. Moreover, the graphical user interface for allowing to present an expansion direction of the frame before expanding the frame to the user has been required.

The present invention has been made in view of inconvenience of the aforementioned conventional art, and a size of a designated frame is changed by rotating a designated frame boundary of a plurality of frame boundaries formed in the window. For this reason, it is possible to rearrange the frame boundary while minimizing the effect on visibility of other frames. Further, according to the present invention, before the user fixes a change of the frame size, a predicted frame in which the frame size is changed is transitionally provided. For this reason, by confirming the predicted frame transitionally displayed on the display, the user can determine an area change of the frame boundary. Additionally, data that the user could not confirm without expanding the frame itself in the past can also be confirmed without changing the conventional frame arrangement.

More specifically, according to the present invention, except a frame boundary formed in contact with a window boundary, a specific end point where two or three frames of a plurality of frames formed within the window are collectively formed is identified. The frame size is changed by rotating at least one of the frame boundaries connected to the specific end point by 90 degrees around on the specific end point. Hereinafter, the end point allowing such rotation move is referred to as a two-degrees-of-freedom end. More specifically, the two-degrees-of-freedom end is referred to as an end point where two frame boundaries are collectively formed, or an end point of the frame where three frame boundaries are collectively formed. In other words, the two-degrees-of-freedom end means an end point having a phase characteristic in which quadrants formed by the frame boundaries are not decreased even when either of two frame boundaries is rotated by 90 degrees.

The quadrants do not decrease by the rotation around on the two-degrees-of-freedom end. It means that whole quantity of frames are stored, namely, the number of objects displayed for every frame is stored.

An end point opposing to the two-degrees-of-freedom end in the frame boundary rotated by 90 degrees is extended to a position connected to the other frame boundary or a window boundary that is present in a direction rotated by 90 degrees. As a result, a frame size of the rotated frame boundary, which has been demarcated before the rotation, can be expanded by an area being extended.

According to the present invention, when a pointer icon approaches an end point on the movable side, based on a phase-relationship between adjacent frames and the window boundary, and the aforementioned two-degrees-of-freedom end, a conventional icon, for example an arrow icon, can be changed into an icon image indicating a rotatable direction so as to graphically display to the user that the frame boundary is rotatable.

Further, when the user drags the mouse in a direction indicated by the displayed icon image, the predicted window object will be displayed. When the user drops pointer means such as a mouse in the state that the predicted window object is displayed, the predicted window object is set in a window object constantly displayed instead of the conventional window object.

According to the present invention, it is possible to provide, while the user minimizes the visibility impairment of data or a document displayed on the frame, an information processing apparatus installing a graphical user interface capable of improving the operability of the frame, and in addition to that, capable of improving the availability of the data or the document by the user, a method thereof and a program thereof.

### BRIEF DESCRIPTION OF THE DRAWINGS

FIG. 1 is a block diagram showing a functional configuration of an information processing apparatus of the present invention.

FIG. 2 is a diagram hierarchically showing a conFIGuration of a software module installed in the information processing apparatus 10 of the present invention.

FIG. 3 is a flow chart of a procedure that a frame boundary rotatable determining module, according to the present invention, may execute.

FIG. 4 is a view showing an embodiment of a frame boundary displayed within a window for generating an end point property list to be used for the present invention.

FIG. 5 is a table showing the end point property list obtained about the embodiment of the frame boundary shown in FIG. 4.

FIG. 6 is a table showing an embodiment of a rotatable display icon list used for the present invention.

FIG. 7 is a schematic diagram showing processing that a frame area rearrangement calculation module and an area rearrangement execution module, in accordance with the present invention, may execute.

FIG. 8 is a view showing an embodiment when a frame boundary rearrangement method according to the present invention is applied to the window displayed on the display screen of the information processing apparatus according to the present invention.

FIG. 9 is a view showing a predicted window object given by the present invention.

FIG. 10 is a view showing a change of a frame arrangement in the window that has conventionally been used.

FIG. 11 is a view showing the change of the frame arrangement in the window that has conventionally been used.

### DETAILED DESCRIPTION OF THE INVENTION

Hereinafter, the present invention will be explained, based on embodiments shown in the drawings, but the present invention is not limited to the embodiments described below.

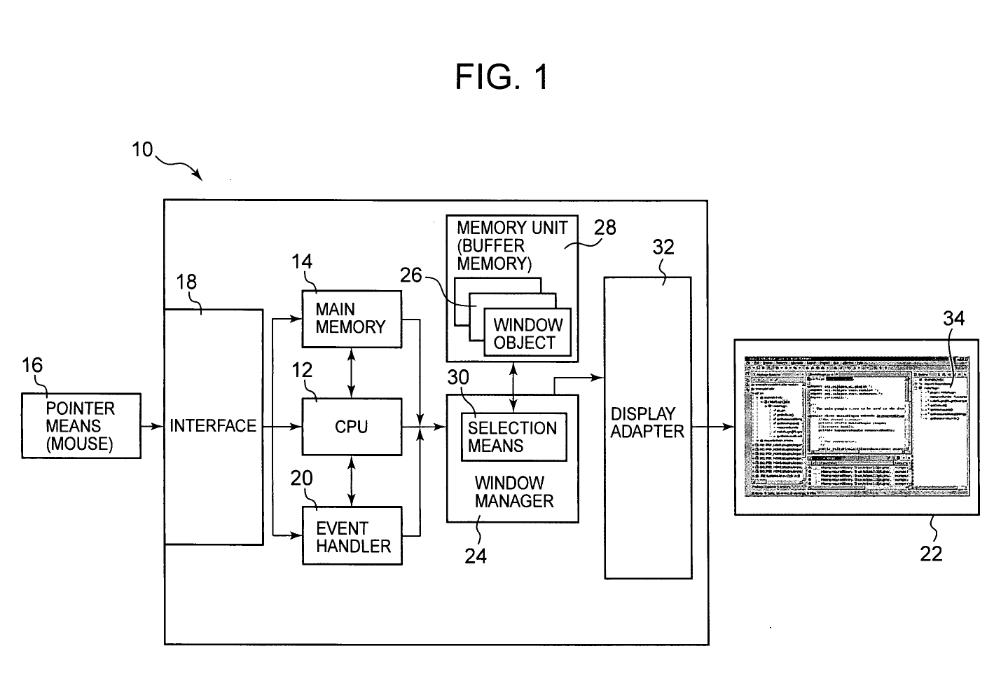

FIG. 1 is a block diagram showing a functional conFIGuration of an information processing apparatus 10 of the present invention. The information processing apparatus 10 of the present invention can be composed as a personal computer or a workstation, and mostly includes a CPU 12, a main memory 14, and an event handler module 20 that receives a signal from pointer means 16 such as a mouse, a stylus pen, or a touchpad, or a keyboard via an interface 18 to obtain positional information for calculating a motion vector. The information processing apparatus 10 further includes a window manager 24 that executes processing for specifying the generation and a size of a window displayed on a display unit 22 and generating a frame within the window. More specifically, the window manager 24 includes window object selection means 30 for selecting a window to be displayed. The window object selection means 30 selects for a table a predicted window object or a window object 26 from a memory unit 28 such as a buffer memory, which stores the window object 26 and the predicted window object.

The window object 26 of the present invention includes an object in which information such as position coordinates of the window, a frame boundary allocation, an object designation to be displayed within the frame or the like is encapsulated. This window object 26 is displayed as a window 34 with a predetermined size on a display screen of the display unit 22 via a display adapter 32. Moreover, the memory unit 28 is used for storing a plurality of window objects having different frame allocations in the present invention, and in response to a user's operation, makes it possible for the window object selection means 30 to select the window object 26 to be displayed.

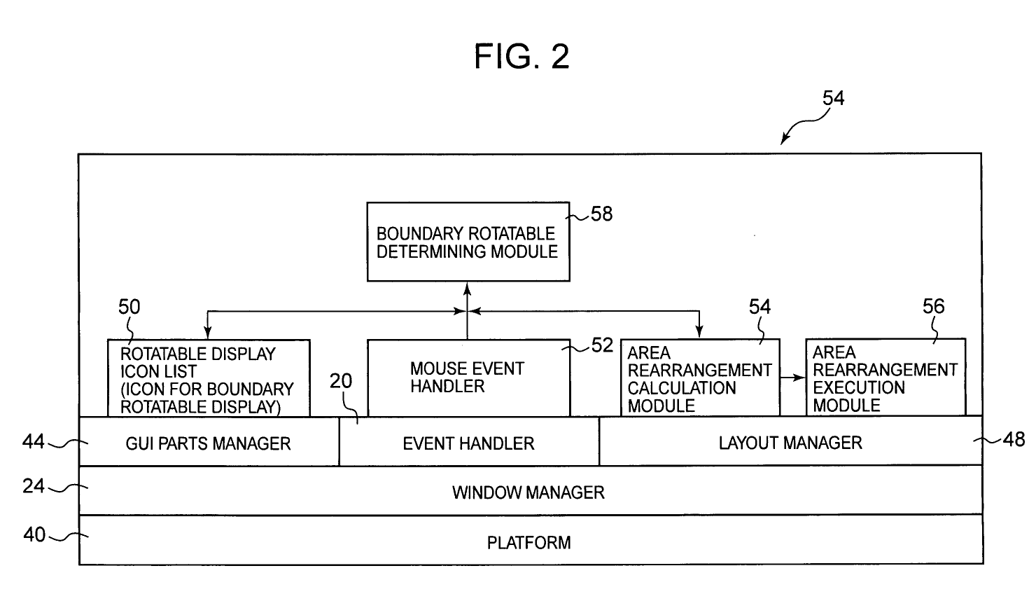

FIG. 2 is a diagram hierarchically showing a conFIGuration of a software module installed in the information processing apparatus 10 of the present invention. As shown in FIG. 2, the information processing apparatus 10 of the present invention is composed on a platform 40 which uses Windows®, Mac OS®, UNIX®, LINUX™ or the like as an operating system (OS), includes the window manager 24 which is based on an architecture of a Windows® system for providing the display unit with a multi-window environment on MS-DOS or an architecture of a X-Windows system for providing with the multi-window environment on a UNIX® environment. At a side of the window manager 24 nearer to the user a GUI parts manager 44, an event handler module 20, and a layout manager 48 are included. The GUI parts manager 44 stores or controls icon image data or the like for providing the user with a graphical user interface (GUI) and provides the user, in response to an external notification, with the icon image data itself or an address of the icon image data stored in appropriate memory means.

The event handler module 20 determines a move of a trackball or a finger of pointer means such as a mouse and a touchpad, and also processes an event signal through a button operation. Moreover, the event handler module 20 monitors a timing displacement of position coordinate data of a pointer icon and calculates a motion vector of the pointer icon. The layout manager 48 executes processing of a frame formed on the window and within the window, and makes it possible to display a window, a frame, and a data object corresponding to the window object. It should be noted that as a software product having a function of the layout manager 48, according to the present invention, various web browser software products such as Internet Explorer, Netscape®, Mozilla or the like might also be included.

Data and a processing module included in the GUI parts manager 44, the event handler module 20, and the layout manager 48 are further shown in FIG. 2. More specifically, the GUI parts manager 44 retains data for controlling various icon images, a registered address of the icon image data or the like, and according to the present invention, particularly controls a rotatable display list 50 for indicating that the frame boundary is rotatable. Meanwhile, the event handler module 20 according to a specific embodiment of the present invention activates a mouse event handler 52. According to the present invention, a module for processing an event from the touchpad, the stylus pen or the like other than the mouse event handler may be included. The layout manager 48 includes a frame area rearrangement calculating module 54 that receives a notification from a frame boundary rotatable determination module 58, which will be described later, and executes processing for rearranging the frame boundary, and an area rearrangement execution module 56 for generating a frame corresponding to a recalculated frame area.

A signal from the mouse event handler 52 is sent to the frame boundary rotatable determination module 58 of the present invention and determines whether the mouse points to a rotatable end point of the rotatable frame boundary. If it is determined that the mouse points to the rotatable end point, the frame boundary rotatable determination module 58 makes the layout manager 48 obtain data for displaying a corresponding icon image from the GUI parts manager 44 and instructs so that a display icon, for example an arrow icon before the determination may be replaced with an icon image corresponding to a rotatable direction.

In addition, the frame boundary rotatable determination module 58 receives motion vector data of the pointer icon from the mouse event handler 52 and compares a direction of the motion vector of the mouse that points to the rotatable end point with a rotatable direction of the end point. If the motion vector has a component of the rotatable direction, the frame boundary rotatable determination module 58 instructs the layout manager 48 to generate a predicted window object corresponding to a new frame boundary and transitionally displays the generated predicted window object. Hereinafter, processing of the frame boundary rotatable determination module 58 used in the present invention and a data structure to be used for it will be explained in detail.

A. Processing of the Frame Boundary Rotatable Determining Module

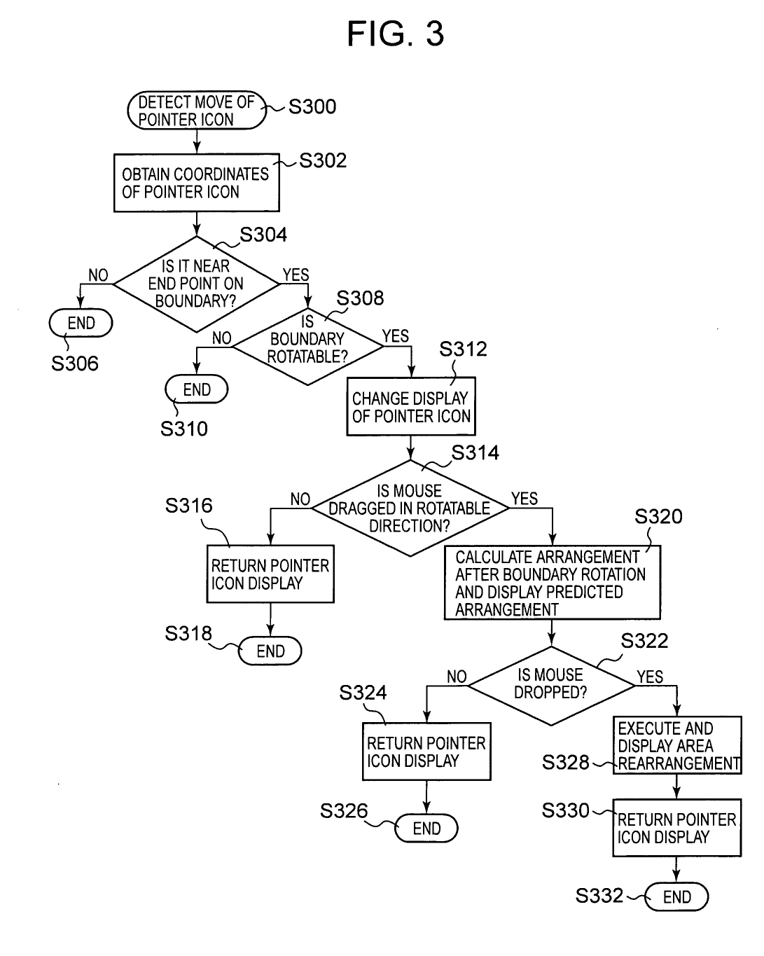

FIG. 3 is a flow chart of a procedure that the frame boundary rotatable determining module, according to the present invention, may execute. According to the procedure shown in FIG. 3, at Step S300, the procedure is started by detecting a move of the pointer icon. At Step S302, the frame boundary rotatable determining module obtains position coordinates of the pointer icon from the event handler. At Step S304, it is determined whether the position coordinates of the pointer icon are coincident with end point coordinates of the frame boundary. If the position coordinates of the pointer icon are not coincident with the end point coordinates of the frame boundary, namely in the case of “no”, the procedure branches to Step S306 to complete the processing. Incidentally, since a constant tolerance is given to a positioning accuracy, a hot spot with a predetermined pixel shape may be provided around on a rotatable end point coordinate, so that the determination at Step S304 may be made in response to the determination that the position coordinates of a mouse pointer are included in this hot spot.

If it is determined based on the determination at Step S304 that the pointer icon is arranged at or adjacent to the end point, namely in the case of “yes” at Step S308, it is determined whether the end point in question is the rotatable end point by looking up an end point property list and responding to whether an identification value or a flag for indicating that the end point in question is rotatable is set. If the end point in question is determined not to have the rotatable property based on the determination at Step S308, namely in the case of “no”, the procedure is completed at Step S310. If, at Step S308, the end point to which the pointer icon points is determined to be coincident with the rotation, namely in the case of “yes”, the rotatable display icon list is looked up at Step S312, so that the layout manager obtains the icon image corresponding to the rotatable direction and that the end point in question is rotatable is noticed to the user through the GUI.

Subsequently, at Step S314, the frame boundary rotatable determining module obtains a motion vector V (Vx, Vy) for indicating a drag direction of the pointer icon from the event handler, and determines by looking up the end point property list whether the motion vector V has a component coincident with the rotatable direction of the rotatable end point. On the determination at Step S314, if it is determined that the drag direction is not coincident with the rotatable direction, namely in the case of “no”, the icon image is kept until the pointer icon disappears adjacent to an end point being determined at Step S316. Meanwhile, when the pointer icon disappears adjacent to the end point, the icon image is returned to an “arrow icon” or the like that is a default setting, and the procedure is then completed at Step S318.

The description will further be made using FIG. 3. On the determination at Step S314, if it is determined that the component (Vx, Vy) of the moving vector V has a component coincident with the rotatable direction, namely in the case of “yes”, the procedure goes to Step S320, and the area rearrangement calculation module calculates the frame boundary data including the rotatable end point in question, and frame boundary data that will be newly generated by notifying the rotatable direction. The calculated data is passed to the area rearrangement execution module to generate a predicted window object and stores it in the memory units such as a buffer memory. At the same time, the predicted window object is transitionally displayed, while the mouse is turned on, instead of the window object having been displayed until then. Moreover, at Step S322, based on a signal of the mouse from the event handler, it is determined whether the mouse is dropped. If the mouse is not dropped, namely in the case of “no”, the icon image of the mouse pointer is returned to the default setting at Step S324, and the procedure is completed at Step S326.

Meanwhile, on the determination at Step S322, if it is determined that the mouse is dropped, namely in the case of “yes”, the predicted window object is fixed to be data of the display window at Step S328, and is still provided to the user thereafter. Subsequently, the icon image is returned to the default setting at Step S330, and the procedure is completed at Step S332.

B. End Point Property List Generation and Data ConFIGuration

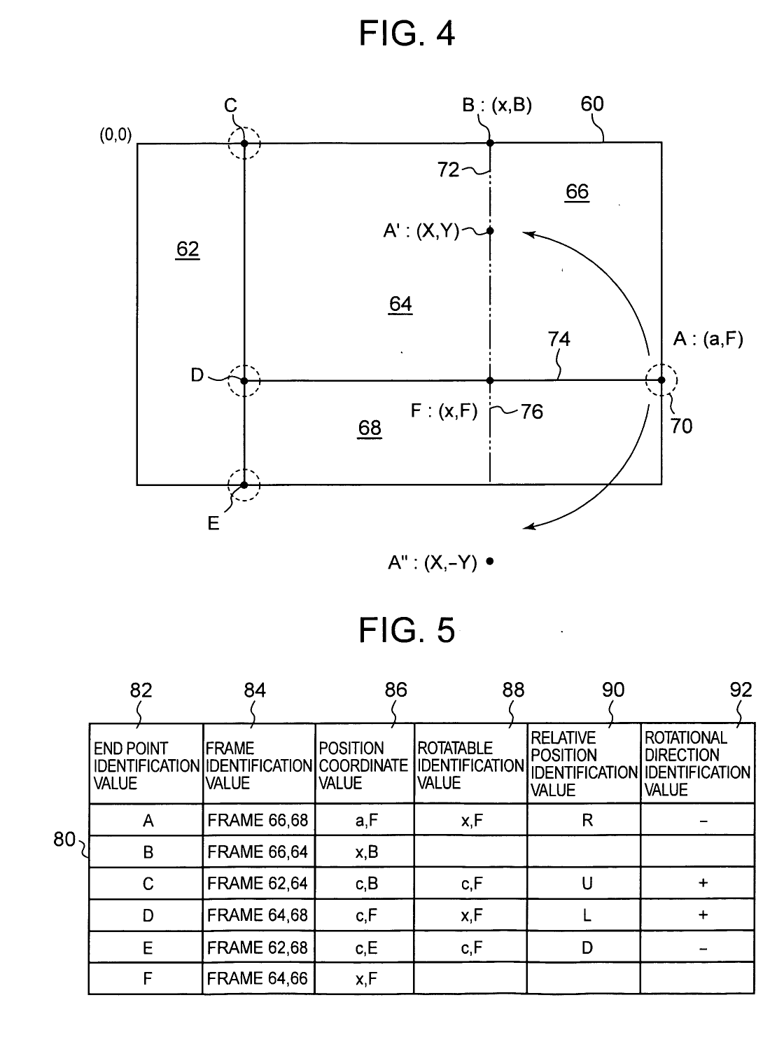

An embodiment of the frame boundary displayed within the window 60 for generating the end point property list to be used for the present invention is shown in FIG. 4. An area inside the window 60 shown in FIG. 4 is composed of four frames, namely a frame 62, a frame 64, a frame 66, and a frame 68. Moreover, in FIG. 4, frame boundary end points determined as the two-degrees-of-freedom end in the present invention, and a hot spot area 70 defined as a hot spot for changing the icon image are shown. According to the embodiment of the frame boundary shown in FIG. 4, end points A through F exist as the end points of the frame boundary. The frame boundary rotatable determining module determines the two-degrees-of-freedom end of the present invention as D and F among these end points. The determination of the two-degrees-of-freedom end according to the present invention is made on the basis of: (1) an end point where two or three frame boundaries share the same pixel coordinate; and (2) an end point where the pixel coordinates in question are not shared with a pixel coordinates which specify the inside area of the window 60.

The reason is that in this two-degrees-of-freedom end, when either of two frame boundaries forming the two-degrees-of-freedom end is rotated by 90 degrees in an appropriate direction, the number of quadrants to be formed is stored. Another reason is that when the frame boundary is shared with a window boundary, it cannot be used as a degree-of-freedom for composing the frame.

When the two-degrees-of-freedom end is determined as described above, the frame boundary forming the two-degrees-of-freedom end is listed, and a flag or the like is set an end point opposing to the two-degrees-of-freedom end in the end point property list as the rotatable end point. Meanwhile, according to another embodiment of the present invention, not the flag but a position coordinates for indicating a center of rotation may be described, and the frame boundary rotatable determining module determines whether a value in the corresponding field is null and can proceed the procedure thereafter. Subsequently, the rotatable direction is determined based on a determination of whether, when further rotated by 90 degrees, the end point has the same direction vector centered on the two-degrees-of-freedom end as that of a different frame boundary composing the two-degrees-of-freedom end in question.

Moreover, the frame boundary rotatable determining module of the present invention determines a direction vector from the two-degrees-of-freedom end of the end point being determined and adds a position identification value for distinguishing upper side (U), down side (D), left (L), and right (R) from the two-degrees-of-freedom end to the end point property list. In order to select the icon image for indicating the rotatable direction of the end point being determined, the position identification value is looked up. Subsequently, the frame boundary rotatable determining module selects a rotatable icon image in a direction opposite to the direction of the position identification value and indicates it to the user when the pointer icon is positioned at the hot spot in the end point in question or adjacent to the end point.

The procedure for determining the rotatable direction in the present invention will further be explained more specifically using FIG. 4. Based on the aforementioned determining procedure, the end point A composes an end point of the frame boundary that composes two-degrees-of-freedom end F, and is marked to be rotatable. Pixel coordinates of the end point A are defined as (a, F) at this time. Meanwhile, a frame boundary 72 is defined by pixel coordinates (x, F) of the end point F from pixel coordinates (x, B) of the end point B. In a manner similar to that, a frame boundary 74 is defined by the pixel coordinates (x, F) and the pixel coordinates (a, F). Here, since the frame boundary rotates around on the two-degrees-of-freedom end F (x, F) as a center (0, 0), pixel coordinates (X, Y) which are given by a rotation of an end point A′ around on the end point F in the 90 degrees direction are given by a following coordinate conversion matrix as a product of coordinate conversion matrixes of rotation and translation.

$$\begin{matrix}( Equation 1 ) & \\ [ \begin{matrix}X \\ Y\end{matrix} ] = [ \begin{matrix}cos θ & sin θ \\ sin θ & - cos θ\end{matrix} ] [ \begin{matrix}1 & - x / F \\ x / a & - x / F\end{matrix} ] [ \begin{matrix}a \\ F\end{matrix} ] & ( 1 )\end{matrix}$$

At this moment, assuming that the end point A is rotated in a counter clockwise direction by 90 degrees, the position coordinates (X, Y) of end point A′ given by the rotation will be obtained as (X, Y)=(0, a−x) (a>x). In this case, since the frame boundary 72 has the same x-coordinate and has the same direction as a vector for the frame boundary 72 to be extended by defining the end point F as a reference point, it is determined that the frame boundary 72 and the frame boundary 74 may overlap one another when the frame boundary 74 is rotated in the counter clockwise direction.

Meanwhile, position coordinates of an end point A″ that is obtained by rotating the end point A in a clockwise direction will be given as (0, x−a), while a frame boundary 76 including the end point A″ that is newly generated is not coincident with the direction vector of the frame boundary 72 around on the end point F and is opposite to the destination of the frame boundary 72. Therefore, it is determined that the overlap may not arise. Based on this determination, the frame boundary rotatable determining module according to the present invention registers a rotational direction around on the two-degrees-of-freedom end corresponding to the end point property list by defining, for example the clockwise direction as “−” and the counter clockwise direction as “+”, thereby making it possible to select the icon image for indicating the rotational direction that will be described below.

FIG. 5 is a table showing the end point property list obtained concerning the embodiment of the frame boundary shown in FIG. 4. As shown in FIG. 5, the end point property list 80 generated in the present invention includes an end point identification field 82 for indicating an end point generated in the window, and a frame identification value field 84 for indicating a frame including the end point in question. Moreover, the end point property list 80 shown in FIG. 5 has a conFiGuration in which a position coordinate field 86 of each end point in the window, a rotatable identification field 88 for indicating a center of rotation of the end point in question which is used as a flag for indicating to be rotatable and is also used as data of a center of rotation, a relative position identification field 90 for indicating a relative position seen from a corresponding two-degrees-of-freedom end, and a rotational direction identification field 92 for indicating a rotational direction are entered. Incidentally, according to another embodiment of the present invention, instead of storing a list that explicitly stores the end point property list shown in FIG. 5, it is also possible, after receiving the position coordinate data and the moving vector of the pointer icon from the event handler, to calculate data indicated in a line of the end point property list on-the-fly, and instructions the result to the GUI parts manager and the layout manager for each event.

When the user operates the pointer icon, if the pointer icon is coincident with each end point, or if the event handler identifies that the pointer icon invades in the hot spot, the frame boundary rotatable determining module looks up the end point property list shown in FIG. 5 and determines based on whether a flag to be filled in the rotatable identification field 88 or a value to be described in the field such as the coordinates is null. Alternatively, if the pointer icon is coincident with each end point, or if the event handler identifies that the pointer icon invades in the hot spot, the frame boundary rotatable determining module calculates corresponding data and determines whether the corresponding end point is rotatable.

According to the embodiment shown in FIG. 5, if the value in the rotatable identification field 88 is not null, the frame boundary rotatable determining module further looks up the relative position identification field 90 and the rotational direction identification field 92 and notifies the result of the layout manager. The layout manager reads an icon image referred to by an identification value specified in a corresponding field in the rotatable display icon list from an appropriate memory area and displays it by replacing default pointer icon. As a result of this processing, the user can know that the end point close to the pointer icon may be rotated in a direction designated by the icon image and the frame may be expanded.

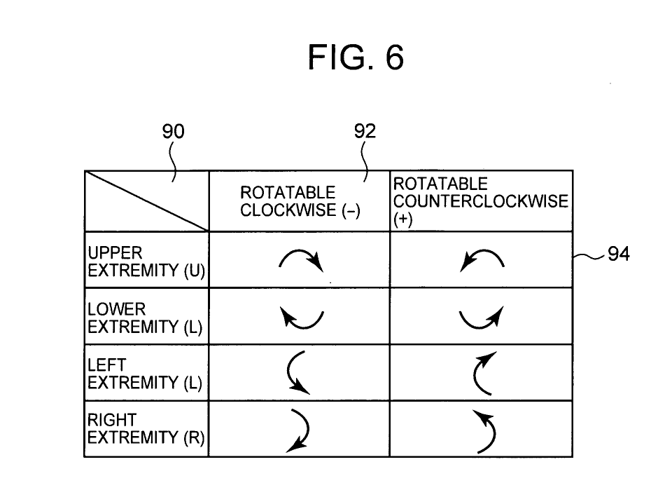

An embodiment of the rotatable display icon list 94 used for the present invention is shown in FIG. 6. As shown in FIG. 6, according to the rotatable display icon list 94 of the present invention, the relative position identification field 90 and the rotational direction identification field 92 are composed as a matrix, and data for using the icon image as the entry are listed. The icon image itself is displayed and shown for convenience in FIG. 6, but an icon name, an address range of the memory for storing the icon image data or the like may be registered as an implemental way. In addition, the icon image is listed as a relationship for indicating to be rotatable in a direction opposite to the relative position specified in the relative position identification field 90, and instructs that the rotation is executed so as to constantly come close to a direction of a corresponding two-degrees-of-freedom end.

When the user further drags the pointer icon in a directed direction with the mouse or the like, the frame boundary rotatable determining module of the present invention instructs the frame area rearrangement calculation module and the area rearrangement execution module to rearrange the frame boundary. The frame area rearrangement calculation module determines a frame influenced by a rearrangement of the frame boundary, calculates end point data of the frame boundary to be newly generated, passes it to the area rearrangement execution module, and stores window data and a rearrangement frame with object information linked to the frame in question in the memory unit as the predicted window object. At the time of completing the storage, the frame boundary rotatable determining module switches the conventional window object of having displayed the frame to the window display of a predicted frame object, and transitionally displays a rearranged frame structure to the user. At this point, if the rearrangement is instructed by the user's dropping a pointer device such as a mouse or the like in this step, the data stored in the predicted frame object is continuously sent to the display adapter and is used as future window displays.

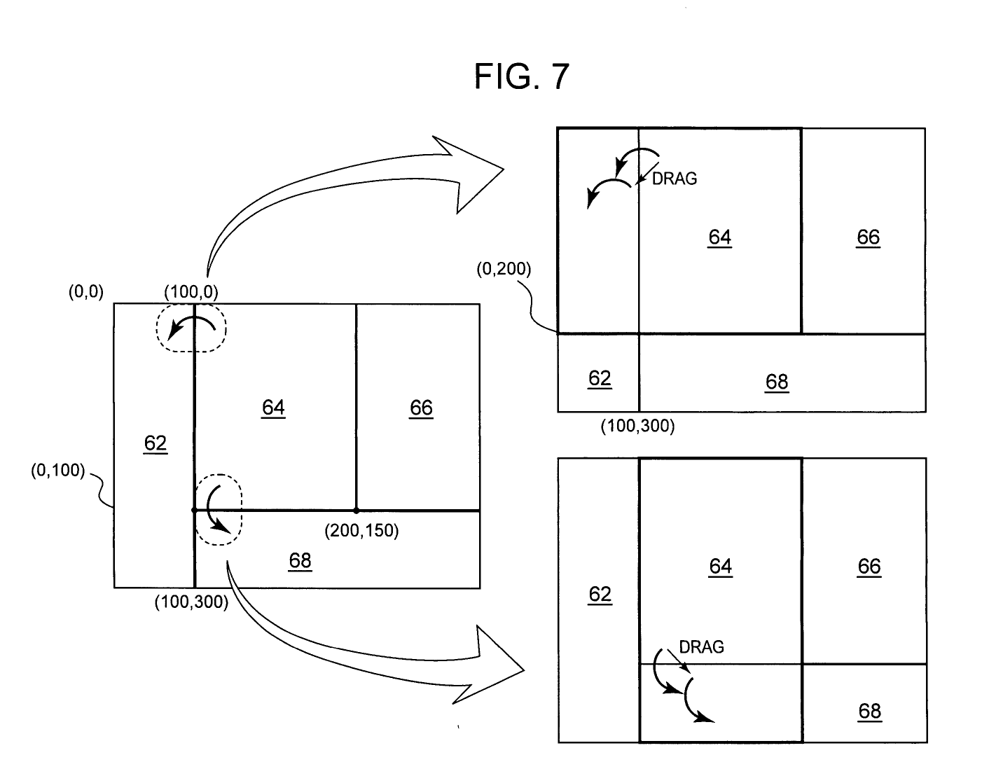

FIG. 7 is a schematic diagram showing the processing executed by the frame area rearrangement calculation module and the area rearrangement execution module according to the present invention. The frame area rearrangement calculation module according to the present invention will identify the frame boundary including the end point in question, if the user designates and drags the rotatable end point. For example, in the embodiment shown in FIG. 7, if the user selects the end point C, the frame 64 and the frame 62 are identified. Subsequently, as for the frame 64, in booting up frame ( ), translate, and resize commands such as Java® Applet, a size of the conventional frame 64, for example, from (100, 0) is assumed to be (100, 150). Additionally, a size of the frame 62 is assumed to be (100, 300) looking from a window origin point (0, 0). In the case of this embodiment, the frame area rearrangement calculation module moves a frame boundary origin point to the window origin point (0, 0) as a new frame 64, and allocates a frame boundary end point to (200, 150) looking from the origin point in question. Furthermore, for the frame 62, it moves the frame boundary origin point to (0, 200) and calculates a new frame boundary end point as (100, 300).

Using this end point data, the area rearrangement execution module executes, for example following processing in Java® Applet or the like to obtain rearrangement data of the frame area, thereby making it possible to display the data object therein.

&Frame f=frame₁₃ 64 ( );

translate (0, 0)

f. resize (200, 150);

frame_64. show; . . .

Meanwhile, if the present invention is applied to a web browser software product such as Internet Explorer, a frame boundary rearrangement may also be executed using a <frameset>, </frameset> tag which are a HTML tag.

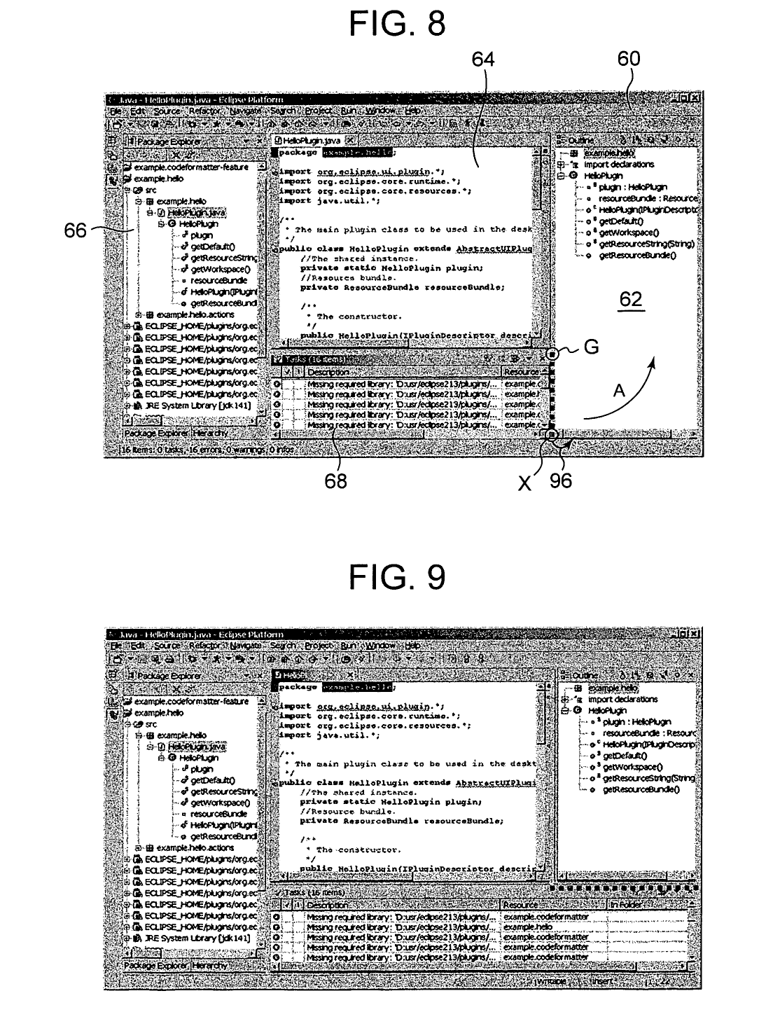

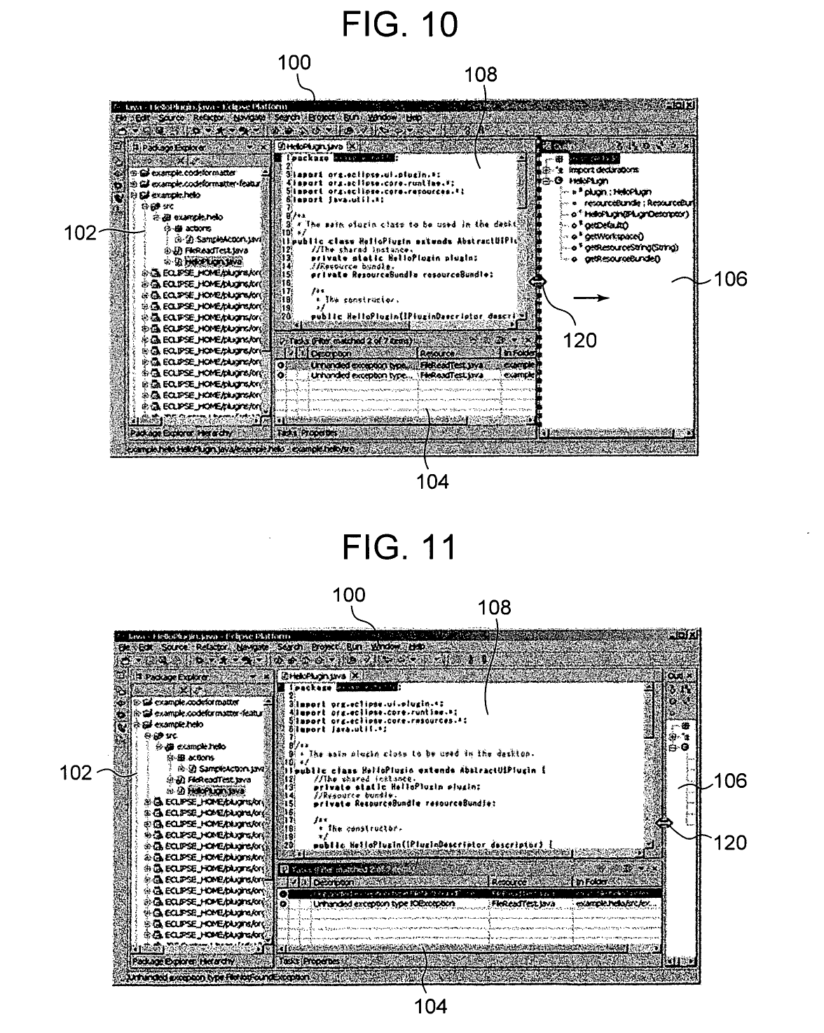

FIG. 8 is a view showing an embodiment when a frame boundary rearrangement method according to the present invention is applied to the window displayed on the display screen of the information processing apparatus according to the present invention. FIG. 8 shows the view in which a plurality of frames, namely frame 62, frame 64, frame 66, and frame 68 are formed inside the window 60. According to the embodiment shown in FIG. 8, it is shown that when the user moves the pointer icon adjacent to an end point X, an icon image 96 will be displayed, and a frame boundary move shown by an arrow A to the right upper side around on two-degrees-of-freedom end point G can be available.

Subsequently, the user, while clicking the mouse, drags it in a direction shown by the icon image. The predicted window object displayed in this step is shown in FIG. 9. It should be noted that if the user does not drop the mouse, the predicted window object shown in FIG. 9 is only selected while the mouse or the like is clicked, and the window object including the original frame boundary is stored in an appropriate area of the memory unit. For this reason, if the display window shown in FIG. 9 is not needed, the user may obtain the window display shown in FIG. 8 again, by returning the mouse, for example to the original position and dropping the mouse. Meanwhile, if the user continuously needs the window display shown in FIG. 9, the window object shown in FIG. 8 is discarded, and thereafter, the predicted window object is displayed as a new display window, by dropping the mouse in the position where the predicted frame object shown in FIG. 9 has been displayed.

A program for executing the method of the present invention can be described in various manners, for example, it can be described using C++, Java®, Java® Applet, Java® Beans, Java® Script the like. Moreover, it may be installed in various kinds of operating systems as a module of a window management software product such as a layout manager. Furthermore, the method of the present invention can also be used as a module of web browser software products such as Internet Explorer, Netscape®, and Mozilla.

As described above, it has been required until now according to the present invention, to expand only a specific frame of a plurality of frames displayed in one window, while suppressing the effect on other frames as little as possible. Moreover, it is possible to provide the graphical user interface allowing to display an expanding direction of the frame to the user before expanding the frame, and to provide the information processing apparatus, the frame rearrangement method, and the program thereof, which have remarkably improved data display-availability in the window to the user.

What is claimed is:

1. An information processing apparatus including a processor, a memory unit, and a display unit for displaying a result processed by said processor, the information processing apparatus comprising:
an event handler module for processing position coordinate data on a window object displayed on said display unit;
a frame boundary rotatable determination module for obtaining position coordinate data of an end point of a frame boundary formed in said window object to determine that said end point is rotatable around on a specific end point; and
a layout manager for processing coordinate conversion around on said specific end point to said end point determined as being rotatable, calculating position coordinate data for changing the frame boundary to generate a predicted window object to be displayed, and storing the predicted window object into said memory unit apart from said window object.

2. The information processing apparatus according to claim 1, in which said layout manager further comprises:
a display window object selecting means, wherein in response to an instruction from said frame boundary rotatable determining module, said display window object selecting means designates said predicted window object to said display window object selecting means to transitionally display said predicted window object on said display unit.

3. The information processing apparatus according to claim 1, further comprising:
end point property data of the end point forming the frame boundary; and
a rotatable display icon list for listing an icon image that indicates a rotatable direction of said end point, wherein said frame boundary rotatable determining module includes means for referring to said end point property data when position coordinate data of a pointer icon from said event handler module lies within a predetermined range from said end point which is rotatable, and determining a rotatable direction of said end point and a relative position to said specific end point.

4. The information processing apparatus according to claim 3, wherein said frame boundary rotatable determining module further comprises:
means for selecting an icon image for indicating a rotatable direction determined from said rotatable display icon list and a rotatable direction corresponding to said relative position, and notifying said layout manager of the icon image, and wherein said layout manager replaces said pointer icon before selection with said selected icon image.

5. The information processing apparatus according to claim 1, wherein said frame boundary rotatable determining module further comprises:
means for calculating a position vector of each opposite end point of said frame boundary from said specific end point; and
means for processing rotation to said position vector and calculating a direction vector of the frame boundary generated after the rotation processing, and the frame boundary rotatable determining module determines that the frame boundary is rotatable, when the direction vector of the frame boundary after said rotation processing is not coincident with the direction vector of the other frame boundary forming said specific end point.

6. The information processing apparatus according to claim 1, wherein said event handler module further comprises:
vector generation means for generating a motion vector from the position coordinate data of said pointer icon, and when said motion vector includes a vector component in a rotatable direction of said end point, said frame boundary rotatable determining module issues an instruction to said layout manager to select said predicted window object.

7. A method of providing a graphical user interface that provides a frame boundary to an information processing apparatus including a processor, a memory unit, and a display unit for displaying a result processed by said processor, the method of causing said information processor to execute the steps of:
processing position coordinate data on a window object displayed on said display unit;
obtaining position coordinate data of an end point of a frame boundary formed in said window object and determining that said end point is rotatable around on a specific end point; and
processing coordinate conversion around on said specific end point to said end point determined as being rotatable, and generating a predicted window object for calculating position coordinate data for changing the frame boundary and displaying the data to register said predicted window object into said memory unit separately from said window object.

8. The method according to claim 7, further comprising:
causing said information processor to execute the step of designating said predicted window object in response to an instruction generated at the step of processing said position coordinate data and displaying it on said display unit.

9. The method according to claim 7, further comprising:
causing said information processor to execute the step of holding end point property data of the end point forming the frame boundary and a rotatable display icon list for listing an icon image that indicates a rotatable direction of said end point, wherein said determining step further comprises the step of referring to said end point property data when position coordinate data of a pointer icon lies within a predetermined range from said end point which is rotatable, and determining a rotatable direction of the said end point and a relative position to said specific end point.

10. The method according to claim 7, wherein said determining step further comprises the step of selecting an icon image for indicating a rotatable direction determined from said rotatable display icon list, and a rotatable direction corresponding to said relative position and issuing an instruction for replacing said pointer icon before selection with said icon image being selected.

11. The method according to claim 7, wherein said determining step further comprises the steps of:
calculating a position vector of each opposite end point of said frame boundary from said specific end point;
processing rotation to said position vector and calculating a direction vector of a frame boundary generated after the rotation processing;
determining whether or not the direction vector of the frame boundary after said rotation processing is coincident with a direction vector of a different frame boundary forming said specific end point; and
determining that the rotation can be processed to said frame boundary, when the direction vector of the frame boundary after said rotation processing is not coincident with the direction vector of a different frame boundary forming said specific end point.

12. A program product for providing a graphical user interface that provides a frame boundary to an information processing apparatus including a processor, a memory unit, and a display unit for displaying a result processed by said processor, the program product of causing said information processor to execute the steps of:
processing position coordinate data on a window object displayed on said display unit and generating a motion vector;
obtaining position coordinate data of an end point of a frame boundary formed in said window object and determining that said end point is rotatable around on a specific end point;
processing coordinate conversion around on said specific end point to said end point determined as being rotatable, and generating a predicted window object for calculating and displaying position coordinate data for changing the frame boundary to store the predicted window object into said memory unit separately from said window object;
issuing an instruction for selecting said predicted window object being stored, when said motion vector includes a vector component in a rotatable direction of said end point; and
transitionally displaying said predicted window object on said display unit in response to said instruction being generated.

13. The program product according to claim 12, wherein said information processor further executes the step of holding end point property data of the end point forming the frame boundary, and a rotatable display icon list for listing an icon image that indicates a rotatable direction of said end point, and wherein said determining step further comprises the step of referring to said end point property data when position coordinate data of a pointer icon is within in a predetermined range from said end point to be rotatable and determining a rotatable direction of the said end point and a relative position to said specific end point.

14. The program product according to claim 12, wherein said determining step further comprises the step of selecting an icon image that indicates a rotatable direction determined from said rotatable display icon list, and a rotatable direction corresponding to said relative position and replacing said pointer icon before selection with said icon image being selected.

15. The program product according to claim 12, wherein said determining step further includes the steps of:
calculating a position vector of each opposite end point of said frame boundary from said specific end point;
processing rotation to said position vector and calculating a direction vector of said frame boundary generated after the rotation processing;
determining whether or not the direction vector of the frame boundary after said rotation processing is coincident with a direction vector of a different frame boundary forming said specific end point; and
determining that the rotation can be processed to said frame boundary, when the direction vector of the frame boundary after said rotation processing is not coincident with the direction vector of a different frame boundary forming said specific end point.
